(19) United States
(12) Patent Application Publication
(10) Pub. No.: US 2013/0086809 A1
(43) Pub. Date: Apr. 11, 2013

(54) Combined handi-hold serving spoon

(71) Applicant: Agostino Difante, San Clemente, CA (US)

(72) Inventor: Agostino Difante, San Clemente, CA (US)

(21) Appl. No.: 13/200,956

(22) Filed: Oct. 5, 2011

(51) Int. Cl. A47J 43/28

(52) U.S. Cl. 30/326

(57) ABSTRACT

A hand held spoon apparatus including a spoon member configured with a recessed area for scooping and holding both the solid and liquid food items, integrally connected to a spoon member arm. Said spoon member arm is resiliently connected to a thumb member arm, that is integrally connected to a thumb member head. Said thumb member head is capable of being placed over the food item when the resilient member is squeezed to hold the food in place while transferring to a plate.

### BACKGROUND

The background of the invention will be discussed in two parts.

1. Field of Invention

The present invention relates in general to a combined spoon apparatus used in a food buffet. More particularly to a spoon member that is that has a recessed area capable of scooping and holding both solid and liquid foods, and a thumb member that is capable of being lowered over the center of the spoon member, for holding the food in place while transferring to a plate.

2. Prior Art

Spoons used in a food buffet line for scooping both liquid and solid food have become commonplace, and a variety of such spoon devices are known in the art, however, the prior art devices are inefficient, and require that a person balance the food within the spoon while they carry it to the plate, and in addition prior art is based on the concept of finger to finger for squeezing and holding food. Prior art is not based on the concept of hand and thumb utilizing the spoon to hold the food and then placing a thumb member over the food to hold it in place while transferring to a plate. It is another feature of the invention to provide an apparatus that is simpler and does not require two different apparatus to accomplish the same task. Other objects of the invention will become apparent with the reading of the specification taken with the drawings wherein there is shown and described the apparatus of the invention.

### SUMMARY

It is the feature of the present invention to provide a new buffet spoon that utilizes the concept of hand and thumb for scooping and holding food. A buffet spoon that is more easy to use, is ergonomically efficient, more flexible in its uses, and is more economical than prior art devices. The present invention relates to a spoon generally used to scoop up both solid and liquid food items within a buffet food pan, and a food holding member that clamps down on the food to hold it in place while traveling to the plate. The holding member presses on the food within the approximate center of the spoon resembling a thumb holding an object in the palm of your hand.

### DRAWINGS

FIG. 1 is an elevational view of prior art device showing the concept of finger to finger for gripping and holding foods.

FIG. 1b is a plan view of a prior art spoon.

FIG. 2 is a perspective view of the spoon apparatus showing the combined spoon member, and the thumb member in the open position.

FIG. 3 is a perspective view of the spoon apparatus showing the combined spoon and thumb member in the closed position. In this figure it is more clearly shown how the thumb member holds the food within the approximate center of the spoon, and how the spoon holds both the sauce and the food.

FIG. 4 is an elevational view of the combined handi-hold serving spoon showing the spoon member, the thumb member, the ergonomic shape, the gripping material on the handle, and the resilient member.

FIG. 5 is a front elevational view of the handi-hold serving spoon

FIG. 6 is a rear elevational view of the handi-hold serving spoon.

FIG. 7 is a top plan view of the handi-hold serving spoon. In this figure it is more clearly shown how the thumb member lands within the approximate center of the spoon member when the apparatus is in the closed position.

FIG. 8 is bottom plan view of the handi-hold serving spoon.

FIG. 9 is an elevational view of a different embodiment of the handi-hold spoon showing, the spoon member, the thumb member, the ergonomic shape, and a different embodiment for the resilient member.

### DESCRIPTION

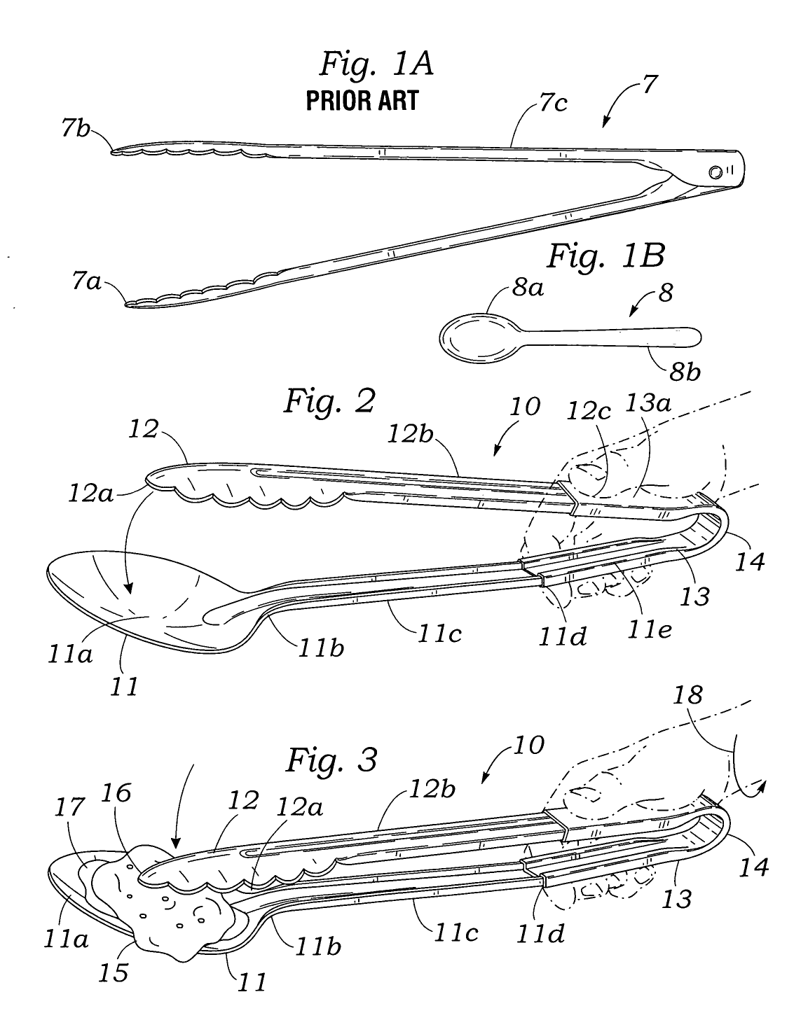

FIG. 1 is an elevational view of the prior art gripping and holding apparatus, generally designated 7. It is shown in this figure how the concept of finger 7a to finger 7b is implemented for gripping and holding items of food. Here is also shown, how the prior art is not capable of picking up both the solid food item and the surrounding liquid or sauce.

FIG. 1b is a plan view of a prior art spoon, generally designated 8. In this figure is shown the generally spoon shaped scooping end 8a of the prior art spoon, the arm like member 8b. Here shown is how prior art is not capable of holding the food item in place, requiring the user to balance the food while transferring to a plate.

FIG. 2 is a perspective view of the combined handi-hold serving spoon generally designated 10 in the open position, and ready to scoop up food. Here is shown the spoon member 11 and the recessed area 11a, the initial primary ergonomic bend area 11b, the lower spoon arm area 11c, the secondary ergonomic bend 11d, and the upper spoon arm area 11e. Also shown is the rubberized gripping material 13 and 13a, the resilient member 14, the thumb member head 12, teeth 12a, thumb arm 12b and thumb force transfer location 12c. Herein it is more easily shown how the ergonomic bends shown 11b, and 11d allow the thumb member head 12 and holding teeth 12a to be lowered on to the center of the recessed area 11a of spoon member 11 to hold and secure food, and to make it easier for the user to scoop up food.

FIG. 3 is a perspective view of the combined handi-hold serving spoon generally designated 10 in the closed position for holding food. In this figure it is more clearly shown how the spoon member 11 is holding both the sauce 17 and the food 16 within its recessed area 11a, and how at times the food item can be bigger shown 15 than the actual size of the spoon member, requiring a person to balance the food item within the spoon if it were not for the thumb member securing it in place. Also more clearly shown is how when the apparatus 10 is squeezed together on resilient member 14, the thumb member head 12 and teeth 12a fall within the approximate center of the spoon 11. Shown is how the ergonomic shape at location 11b and 11d help to facilitate the thumb member head 12 to land within the approximate center of spoon member 11. Also shown is how a flip of the wrist 18 while holding the food in place can discard the unwanted sauce back into the buffet pan.

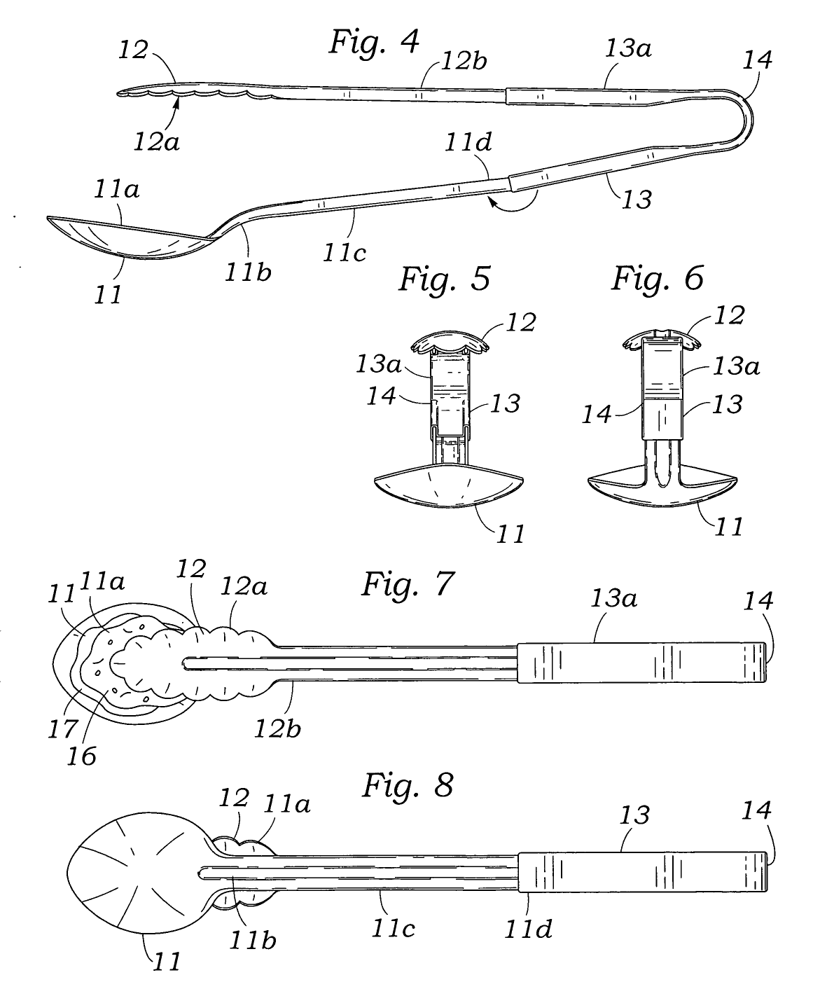

FIG. 4 is an elevational view of the handi-hold serving spoon in the open position. Here all the components of the invention are more clearly shown. The spoon member 11 and the recessed area 11a, the ergonomic bend 11b, the lower spoon arm 11c, the second ergonomic bend 11d, the upper spoon arm member 13 and 13a both with its rubberized gripping surface, the monolithic resilient member 14 also with its rubberized gripping surface, the thumb member arm 12b, the thumb member head 12, and the thumb member teeth 12a. Here is more clearly shown how the spoon member extends slightly further out than the thumb member head above.

FIG. 5 is a front elevational view of the handi-hold serving spoon. Here shown is how the resilient member 14 is manufactured integral and monolithic with the spoon apparatus.

FIG. 6 is a rear elevational view of the handi-hold serving spoon. Here shown is how the resilient member 14 is manufactured integral and monolythic with the spoon apparatus.

FIG. 7 is a top plan view of the handi-hold serving spoon, in the closed position. In this figure it is more clearly shown how the thumb member 12 head and teeth 12a fall within the approximate center of spoon member 11 and recessed area 11a to hold both the food 16 and the sauce 17, and how the spoon member extends further out than the thumb member head above.

FIG. 8 is a bottom plan view of the handi-hold serving spoon in the closed position. In this figure, it is shown how the spoon member 11 and how both ergonomic bends 11b and 11d help to allow the thumb member 12 to land within the approximate center of spoon member 11.

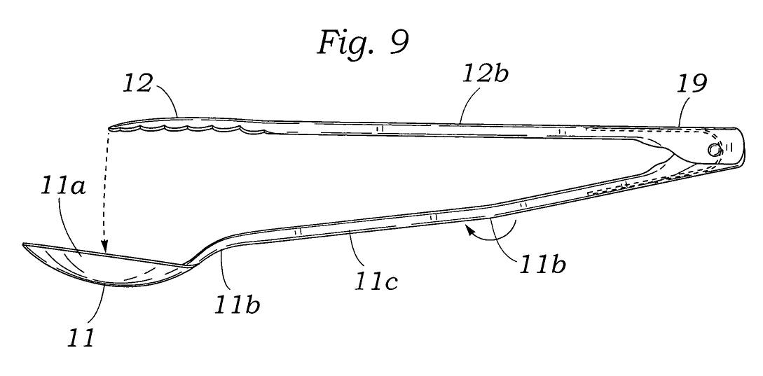

FIG. 9 is an elevational view of a different embodiment of the handi-hold spoon showing a spring 19 instead of manufactured monolithically.

1. A combined spoon apparatus comprising:
a hand held spoon apparatus
a spoon member configured with a recessed area for scooping and holding both solid and liquid food items, resiliently connected to a thumb member head for holding said food items within the spoon member while transferring food items to a plate.

2. The combined spoon apparatus of claim 1 comprising:
said spoon member configured with a recessed area capable of holding both solid and liquid foods integrally connected to a spoon member arm that is resiliently connected to a thumb member arm and thumb member head
said resilient member is substantially capable of returning to its original position after being squeezed and released.

3. The combined spoon apparatus of claim 1 wherein;
said resilient member can be manufactured integral and monolithically with the spoon apparatus to physically connect the spoon member arm and the thumb member arm.

4. The combined apparatus of claim 1 wherein:
said resilient member can be manufactured independently such as a spring and pin to physically attach the spoon member arm to the thumb member arm.

5. A combined hand held spoon apparatus comprising:
a spoon member configured with a recessed area for scooping and holding both solid and liquid food items,
a spoon member arm connected to said spoon member,
a thumb member head for holding said foods within the spoon member while transferring food items to a plate,
a thumb member arm connected to the said thumb member head,
a resilient member, connecting together the said spoon member arm and the said thumb member arm substantially elastic to return to its original position after being squeezed.

6. The combined hand held spoon apparatus of claim 5 wherein;
said spoon member arm is configured to have an ergonomic shape that is bent slightly upward in a least one location to substantially meet the said thumb member within the approximate center of said spoon member recessed area to hold food items in place while transferring to a plate.

7. A combined hand held spoon apparatus of claim 5 wherein;
said thumb member is capable of being placed over said spoon member by squeezing the said resilient member,

8. The combined spoon apparatus of claim 1 wherein;
said combined spoon apparatus can be made of any material

9. The combined spoon apparatus of claim 1 wherein:
said combined spoon apparatus is made of stainless steel

10. The combined spoon apparatus of claim 5 wherein;
said spoon member is connected to said spoon member arm, and said spoon member arm is ergonomically configured to allow the user to easily scoop up foods within a buffet pan.

11. The combined spoon apparatus of claim 5 wherein;
said spoon member and said thumb member head are configured to scoop up food items within a buffet pan and hold them in place while transferring to a plate, and
said spoon member and said thumb member head are configured to hold the food items within the recessed area of the spoon member.
